(19) United States
(12) Patent Application Publication
(10) Pub. No.: US 2017/0237174 A1
(43) Pub. Date: Aug. 17, 2017

(54) Broad Band Diversity Antenna System

(71) Applicant: Netgear, Inc., San Jose, CA (US)

(72) Inventors: Paul NYSEN, San Jose, CA (US); Chia-Wei LIU, Fremont, CA (US)

(21) Appl. No.: 15/043,465

(22) Filed: Feb. 12, 2016

(51) Int. Cl. H01Q 11/10; H01Q 1/50

(52) U.S. Cl. CPC H01Q 11/10; H01Q 1/50

(57) ABSTRACT

A broad band diversity antenna system comprises a system of log periodic antennas (LPA) and dipole antennas. Two LPAs form a balanced dipole by feeding the back ends of the LPA. The feed is improved by the addition of a balun to ensure RF balance. Because a dipole only requires narrow bandwidth, a simple balun is constructed from coax cable or a transmission line, thus providing low cost construction.

### FIELD

The invention relates to antennas. More particularly, the invention relates to a broad band diversity antenna system.

### BACKGROUND

### Log Periodic Antennas

A log-periodic antenna (LP), also known as a log-periodic array or log-periodic aerial, is a multi-element, directional, antenna designed to operate over a wide band of frequencies.

The most common form of log-periodic antenna is the log-periodic dipole array or LPDA, The LPDA consists of a number of half-wave dipole driven elements of gradually increasing length, each consisting of a pair of metal rods. The dipoles are mounted close together in a line, connected in parallel to the feed line with alternating phase. Electrically, it simulates a series of two or three-element Yagi antennas connected together, each set tuned to a different frequency.

### Dipole Antennas

In radio and telecommunications a dipole antenna or doublet is the simplest and most widely used class of antenna. It consists of two identical conductive elements such as metal wires or rods, which are usually bilaterally symmetrical. The driving current from the transmitter is applied, or for receiving antennas the output signal to the receiver is taken, between the two halves of the antenna. Each side of the feed line to the transmitter or receiver is connected to one of the conductors. This contrasts with a monopole antenna, which consists of a single rod or conductor with one side of the feed line connected to it, and the other side connected to some type of ground. A common example of a dipole is the “rabbit ears” television antenna found on broadcast television sets.

The most common form of dipole is two straight rods or wires oriented end to end on the same axis, with the feed line connected to the two adjacent ends. This is the simplest type of antenna from a theoretical point of view. Dipoles are resonant antennas, meaning that the elements serve as resonators, with standing waves of radio current flowing back and forth between their ends. So the length of the dipole elements is determined by the wavelength of the radio waves used. The most common form is the half-wave dipole, in which each of the two rod elements is approximately ¼ wavelength long, so the whole antenna is a half-wavelength long. The radiation pattern of a vertical dipole is omnidirectional; it radiates equal power in all azimuthal directions perpendicular to the axis of the antenna. For a half-wave dipole the radiation is maximum, 2.15 dBi perpendicular to the antenna axis, falling monotonically with elevation angle to zero on the axis, off the ends of the antenna.

### Antenna Diversity

Antenna diversity, also known as space diversity or spatial diversity, is any one of several wireless diversity schemes that uses two or more antennas to improve the quality and reliability of a wireless link. Often, especially in urban and indoor environments, there is no clear line-of-sight (LOS) between transmitter and receiver. Instead the signal is reflected along multiple paths before finally being received. Each of these bounces can introduce phase shifts, time delays, attenuations, and distortions that can destructively interfere with one another at the aperture of the receiving antenna.

Antenna diversity is especially effective at mitigating these multipath situations. This is because multiple antennas offer a receiver several observations of the same signal. Each antenna experiences a different interference environment. Thus, if one antenna is experiencing a deep fade, it is likely that another has a sufficient signal. Collectively such a system can provide a robust link. While this is primarily seen in receiving systems (diversity reception), the analog has also proven valuable for transmitting systems (transmit diversity) as well.

While log periodic and dipole antennas are known, it might be desirable to use both log periodic and dipole antennas in applications where the benefits of a diversity antenna system are advantageous.

### SUMMARY

Embodiments of the invention provide a broad band diversity antenna system which, in a presently preferred embodiment, comprises a system of log periodic antennas (LPA) and dipole antennas. Embodiments of the invention use two LPAs to form a balanced dipole by feeding the back ends of the LPA. In embodiments of the invention, the feed is improved by the addition of a balun to ensure RF balance. Because a dipole only requires narrow bandwidth, a simple balun is constructed from coax cable or a transmission line, thus providing low cost construction.

### DRAWINGS

FIG. 1 is a perspective schematic view of a direct beam antenna;

FIG. 2 is a graph showing an LPA at 10 dBi;

FIG. 3 is a perspective schematic view of a single pole LPA;

FIG. 4 is a perspective schematic view of a broad band diversity antenna system that comprises a system of LPAs and dipole antennas according to the invention;

FIG. 5 is a graph showing reflection and isolation in a broad band diversity antenna system according to the invention;

FIGS. 6A-6D are a series of graphs showing beam patterns in a low band for a broad band diversity antenna system according to the invention;

FIGS. 7A-7D are a series of graphs showing beam patterns in a high band for a broad band diversity antenna system according to the invention;

FIG. 8 is a perspective schematic view of a self supported broad band diversity antenna system that comprises a system of LPAs and a dipole antenna according to the invention;

FIG. 9 is close up perspective schematic view of a broad band diversity antenna system that comprises a system of LPAs and a dipole antenna according to the invention;

FIG. 10 is a 3D image of a dual printed circuit board (PCB) broad band diversity antenna system that comprises a system of LPAs and a dipole antenna according to the invention;

FIG. 11 is a 3D image of a single PCB broad band diversity antenna system that comprises a system of LPAs and a dipole antenna according to the invention;

FIG. 12 is a front side view of a single PCB broad band diversity antenna system that comprises a system of LPAs and a dipole antenna according to the invention;

FIG. 13 is a back side view of a single PCB broad band diversity antenna system that comprises a system of LPAs and a dipole antenna according to the invention;

FIG. 14 is a first schematic representation of a broad band diversity antenna system that comprises a system of LPAs and a dipole antenna;

FIG. 15 is an alternative schematic representation of a broad band diversity antenna system that comprises a system of LPAs and a dipole antenna according to the invention;

FIG. 16 is a first 3D representation of a broad band diversity antenna system that comprises a system of LPAs and a dipole antenna according to the invention;

FIG. 17 is a further 3D representation of a broad band diversity antenna system that comprises a system of LPAs and a dipole antenna according to the invention;

FIG. 18 is a close up schematic representation of a low band match element in a broad band diversity antenna system that comprises a system of LPAs and a dipole antenna according to the invention;

FIG. 19 is a close up schematic representation of an LPA feed element in a broad band diversity antenna system that comprises a system of LPAs and a dipole antenna according to the invention;

FIG. 20 is a schematic diagram showing a discrete matching circuit for a broad band diversity antenna system that comprises a system of LPAs and a dipole antenna according to the invention;

FIG. 21 is a front side view of an antenna and a main board for a broad band diversity antenna system that comprises a system of LPAs and a dipole antenna according to the invention;

FIG. 22 is a back side view of an antenna and a main board for a broad band diversity antenna system that comprises a system of LPAs and a dipole antenna according to the invention; and

FIG. 23 is a back side view showing component values a main board for a broad band diversity antenna system that comprises a system of LPAs and a dipole antenna according to the invention.

### DESCRIPTION

Embodiments of the invention provide a broad band diversity antenna system which, in a presently preferred embodiment, comprises a system of log periodic antennas (LPA) and dipole antennas. Embodiments of the invention use two LPAs to form a balanced dipole by feeding the back ends of the LPA. In embodiments of the invention, the feed is improved by the addition of a balun to ensure RF balance. Because a dipole only requires narrow bandwidth, a simple balun is constructed from coax cable or a transmission line, thus providing low cost construction.

A presently preferred embodiment of the invention provide a dual band antenna comprising a low band 700 MHz to 960 MHz top loaded dipole and a high band 1.4 GHz to 2.7 GHz broad band LPA. Embodiments of the invention allow the antenna system to rotate physically. Those skilled in the art will appreciate that the invention is not limited to the foregoing bands and/or frequencies, and that any number of bands and/or range of frequencies can be provided in accordance with the invention disclosed herein.

Embodiments of the invention are fixed and use two oppositely pointing LPAs for the high band. Each LPA has a cardioid pattern in both the vertical and horizontal directions, where polarization is vertical in the azimuth plane. The LPAs can be placed back to back to ensure orthogonality, i.e. isolation between the antennas.

In embodiments of the invention, the low band uses a single top loaded vertical dipole and operates in a differential mode between the proximal ends of the two LPAs. A result of the differential feed across the ends of the two LPAs produces a single low band horizontal dipole. Because the low band modes are cross polarized, the modes are orthogonal and therefore isolated.

Embodiments of the invention can include, inter alia, a mechanical rotating beam (direct beam), a 3D LPA, a 2D LPA, a combined LPA and dipole antenna, and a non-rotating dual LPA and dipole antenna.

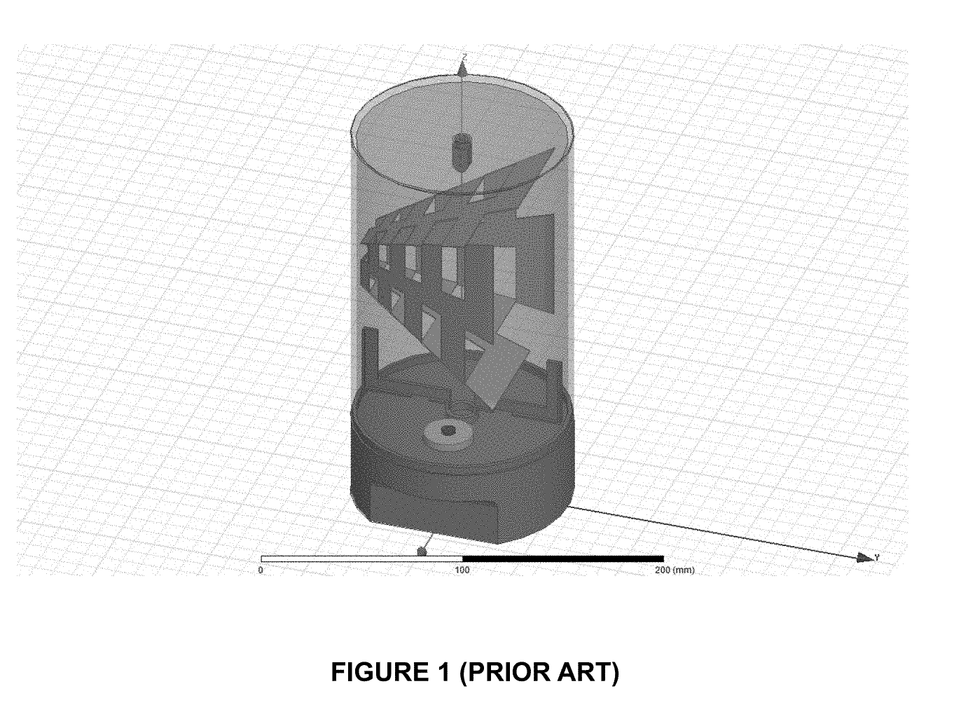

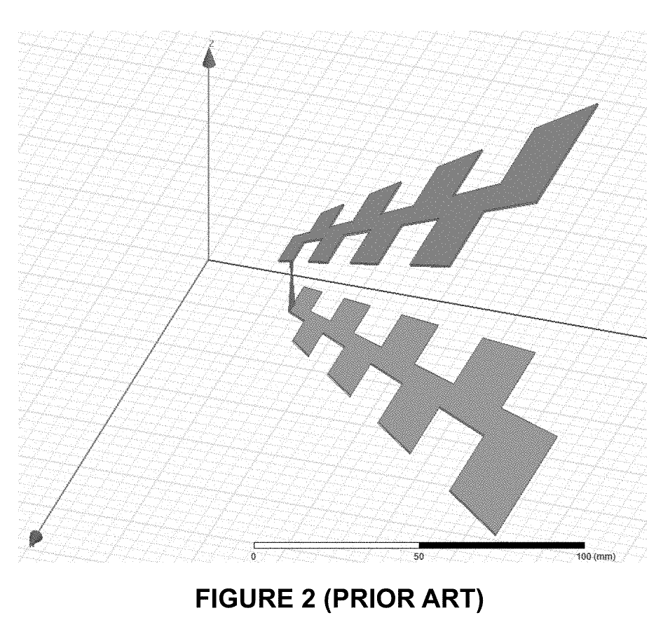

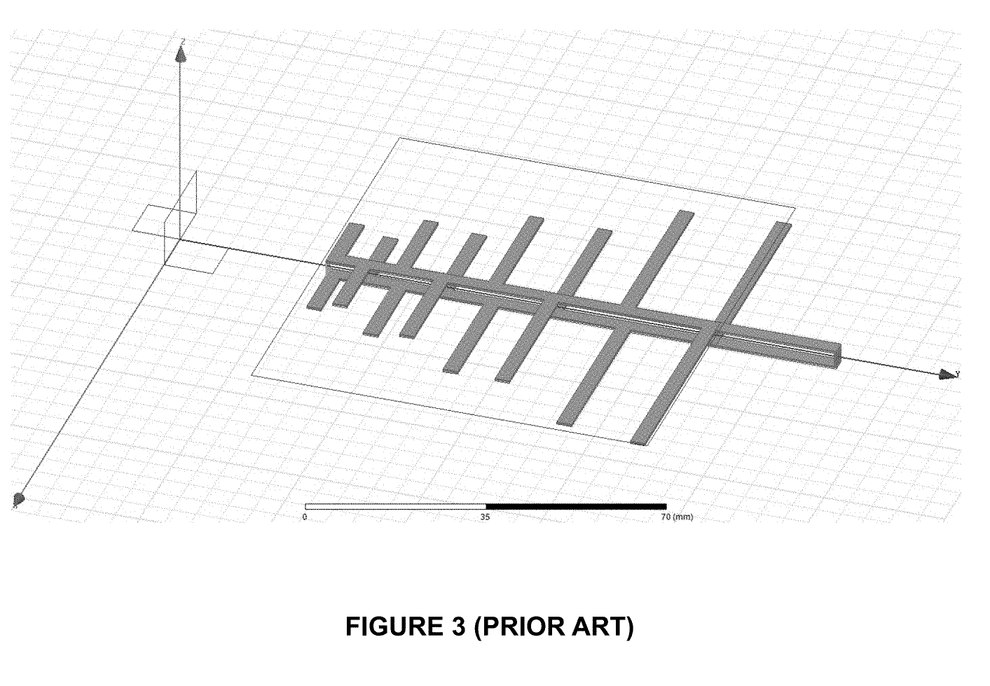

FIGS. 1-3 provide examples of the state of the art. FIG. 1 is a perspective schematic view of a direct beam. FIG. 2 is a graph showing an LPA at 10 dBi. FIG. 3 is a perspective schematic view of a single pole LPA.

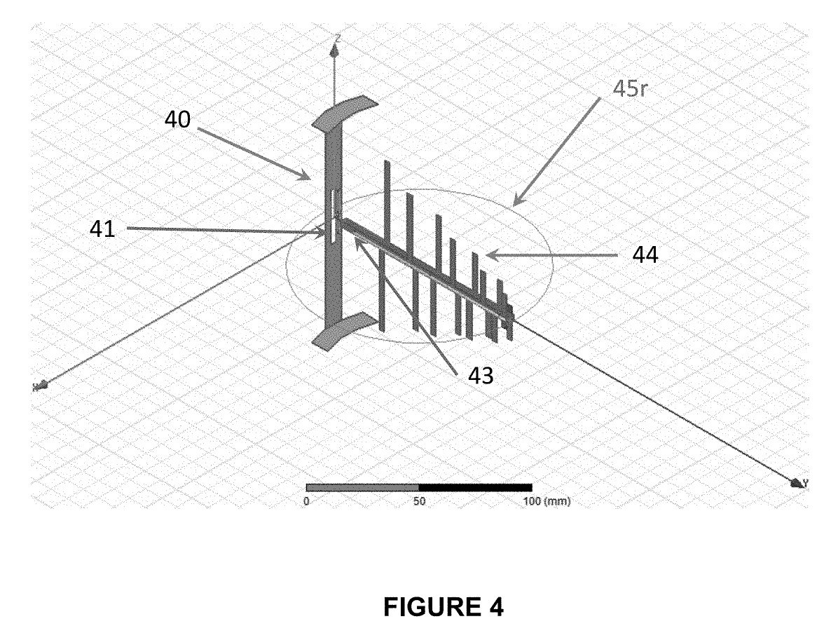

FIG. 4 is a perspective schematic view of a broad band diversity antenna system that comprises a system of log periodic antennas (LPA) and dipole antennas according to the invention. The embodiment of FIG. 4 includes a low band LTE top loaded dipole antenna 40 connected to an RF device by a low band LTE coax feed 42 which, in this embodiment has a 1.37 mm OD. The overall antenna height in this embodiment is 120 mm. A high band LTE LPA 44 is connected to an RF device by a high band LTE coax feed 43 which, in this embodiment, ahs a 1.37 mm OD. The inside cylinder diameter 45 of this antenna system is 120 mm.

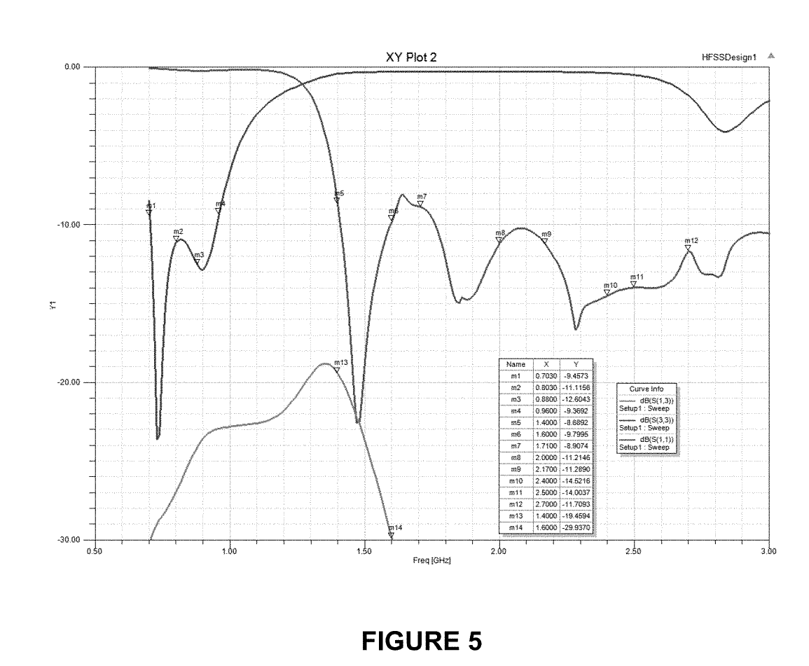

FIG. 5 is a graph showing reflection and isolation in a broad band diversity antenna system according to the invention.

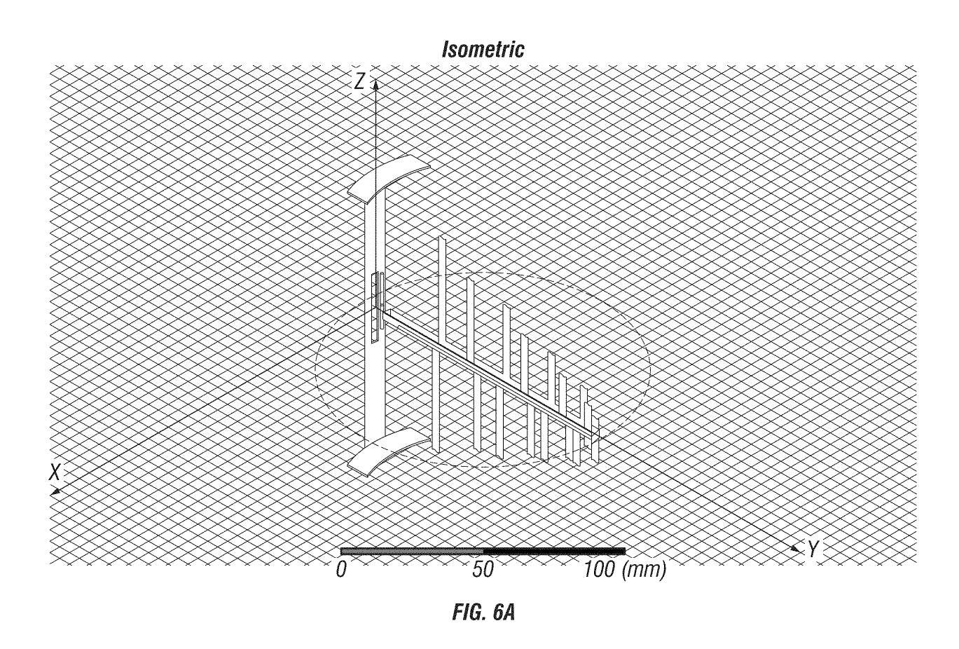

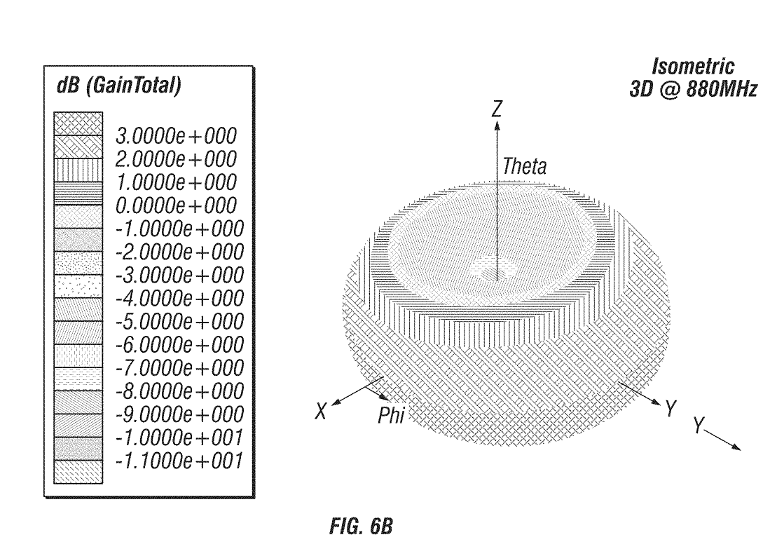

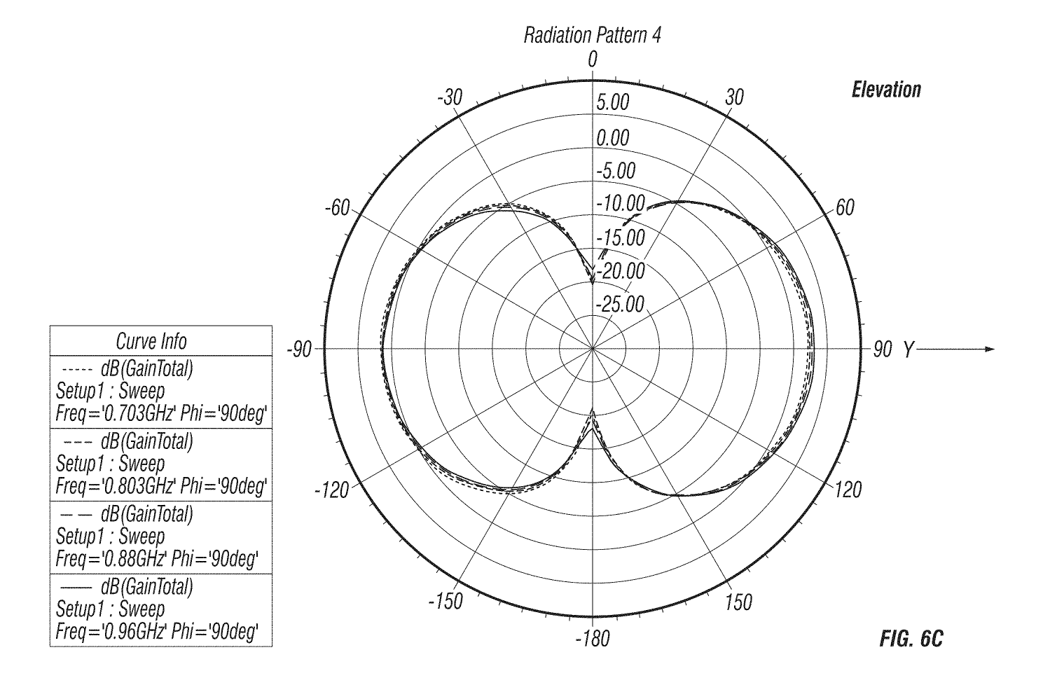

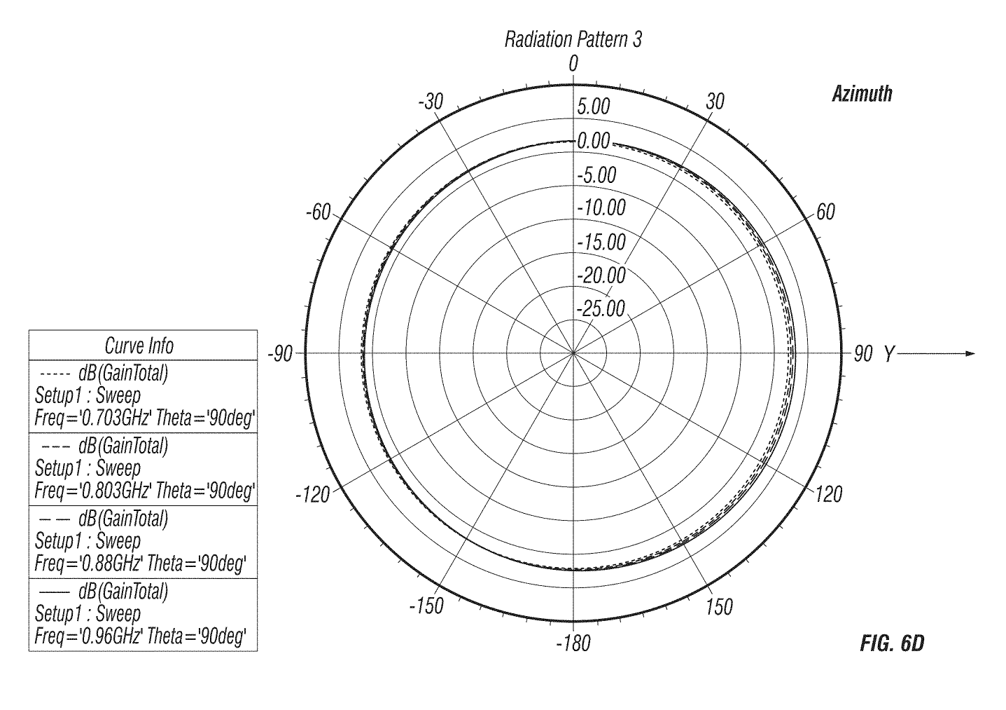

FIGS. 6A-6D are a series of graphs showing beam patterns in a low band for a broad band diversity antenna system according to the invention.

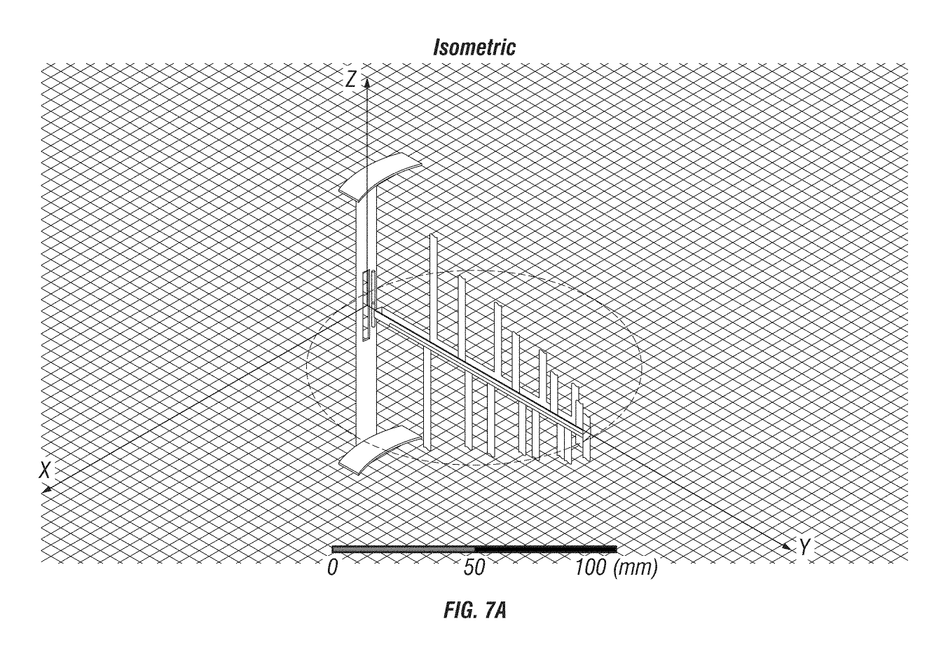

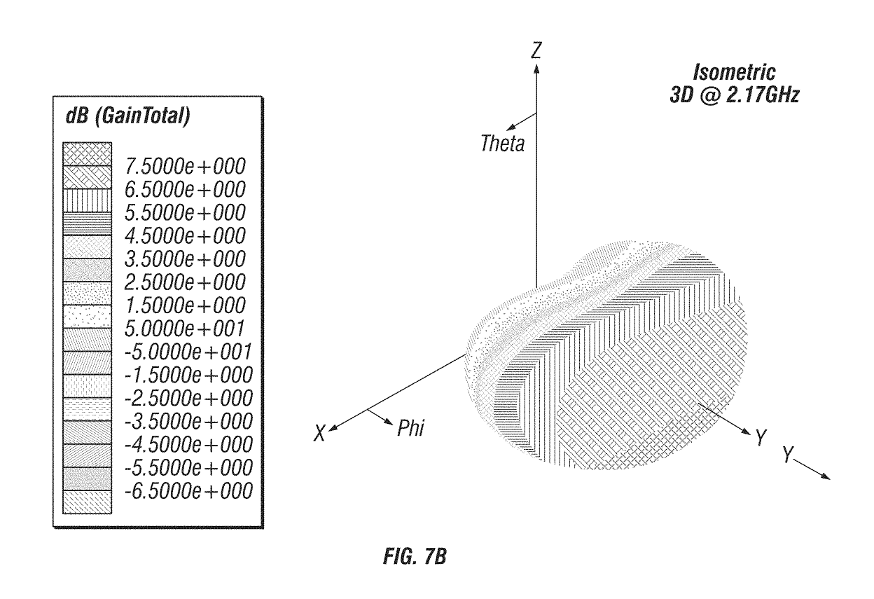

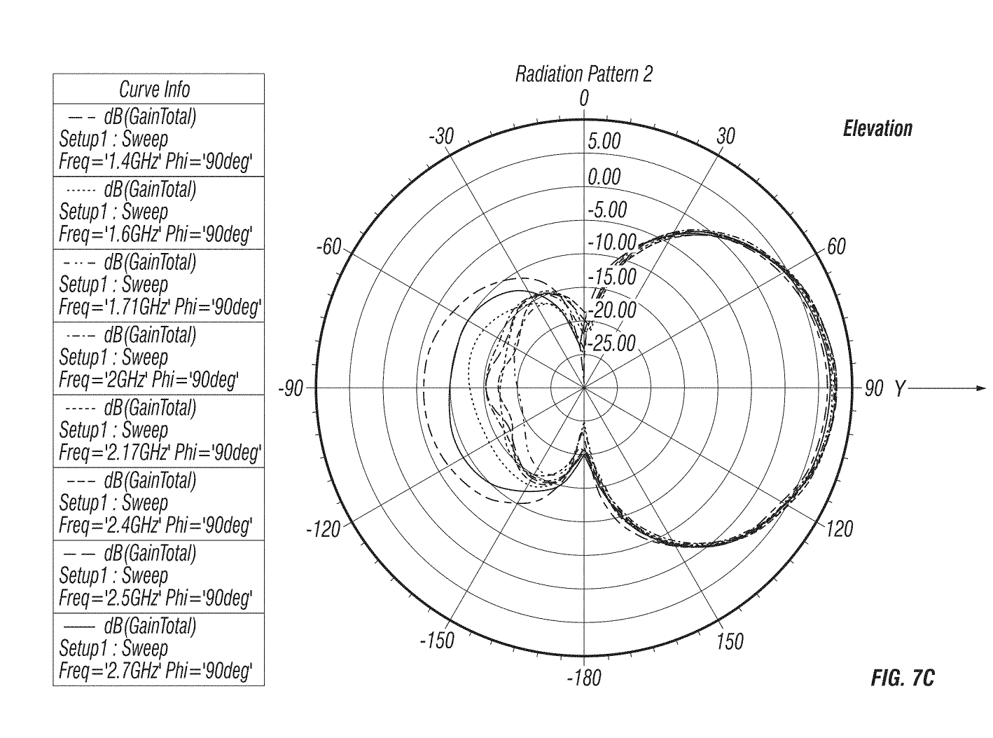

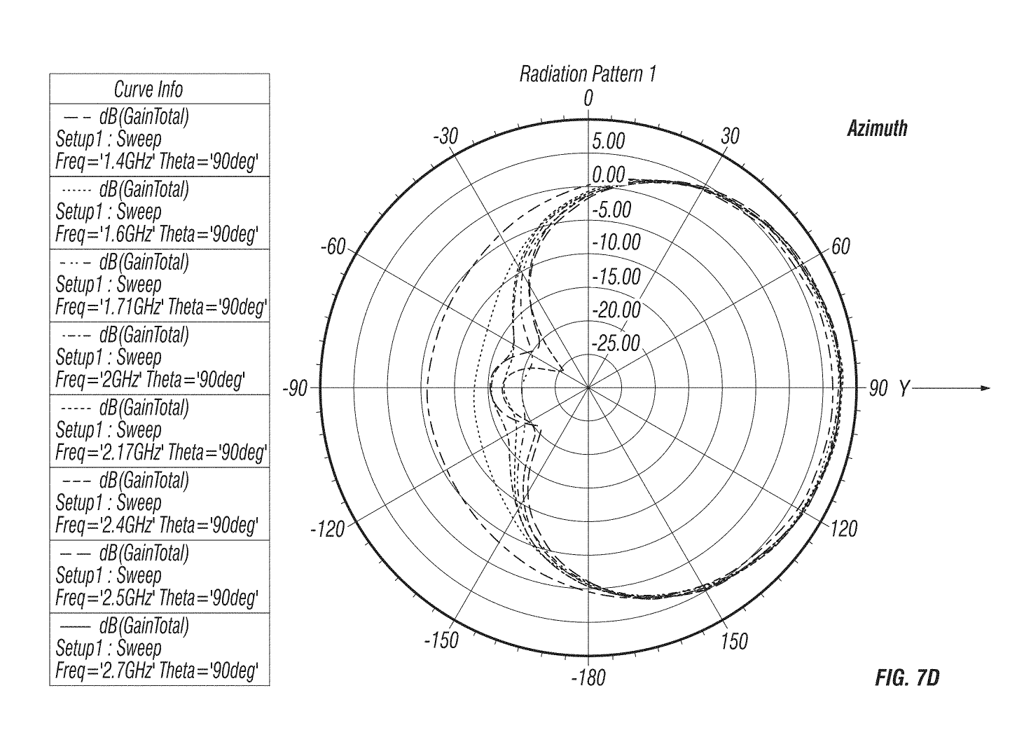

FIGS. 7A-7D are a series of graphs showing beam patterns in a high band for a broad band diversity antenna system according to the invention.

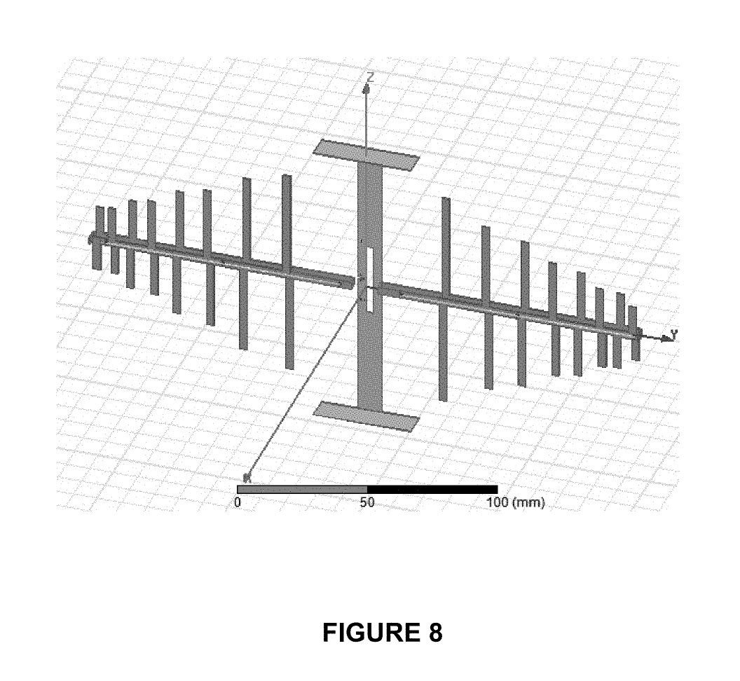

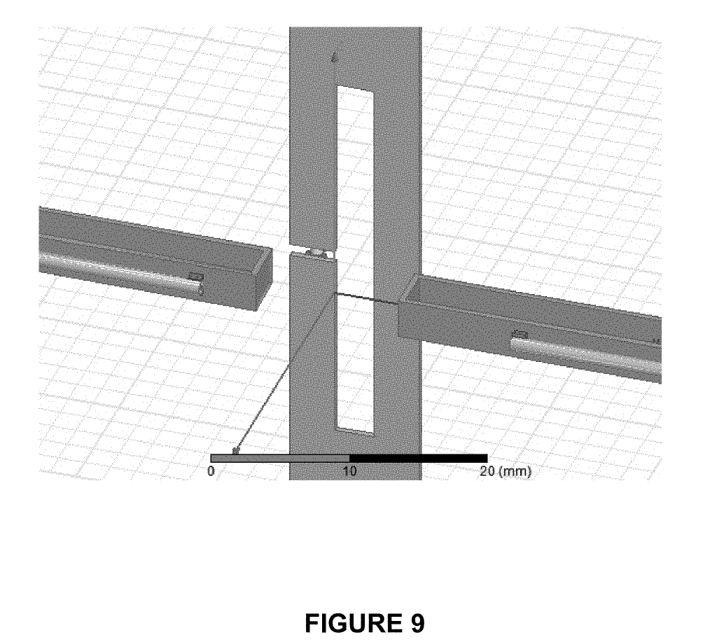

FIG. 8 is a perspective schematic view of a self supported broad band diversity antenna system that comprises a system of LPAs and a dipole antenna according to the invention; and FIG. 9 is close up perspective schematic view of a broad band diversity antenna system that comprises a system of LPAs and a dipole antenna according to the invention.

### Dual PCB System

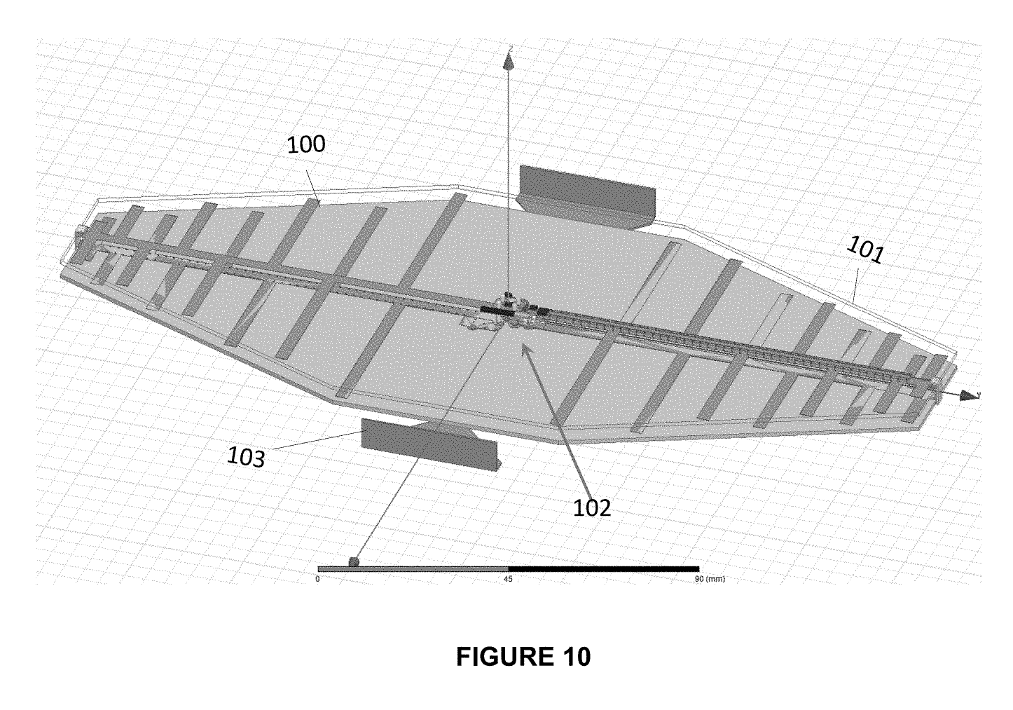

FIG. 10 is a 3D image of a dual PCB broad band diversity antenna system that comprises a system of LPAs and a dipole antenna according to the invention. In FIG. 10, the front side PCB is shown as being transparent to allow depiction of all of the antenna system elements. These element include LPA A 100, LPA B 101, the low band vertical dipole 103, and a horizontal matching circuit 102.

### High Band LPA

In embodiments of the invention, the structure for the high band LPA antenna comprises interleaved elements that are printed on two opposing PCBs having copper on facing surfaces (see FIGS. 10-13). The structure requires only air between the PCBs. Both antennas require no matching components. Final tuning is required inside the cradle housing. High band and low band antennas require a diplexer.

### Low Band Dipoles

In embodiments of the invention, the structure for the low band vertical antenna comprises a top loaded dipole that is coupled by a delta match that uses a series capacitor to complete the match. In embodiments of the invention, the capacitor is split on either side of the differential feed to support the balance.

The low band horizontal antenna also comprises a dipole. Because the two LPA antennas are isolated, the horizontal dipole is formed by driving their common mode in a differential fashion. In embodiment of the invention, the feed uses five discrete matching components comprising one series resonator. The return loss is only 7 dB. The addition of another resonator, while improving the match, might make tuning very sensitive and is not preferred for the horizontal antenna.

### Single PCB System

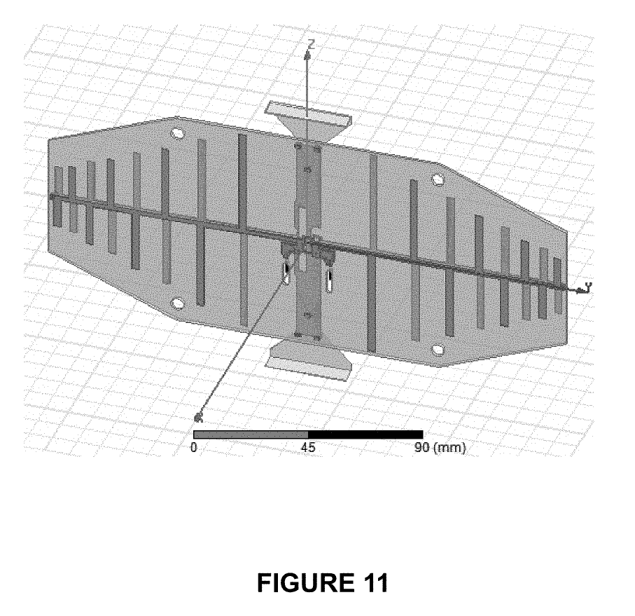

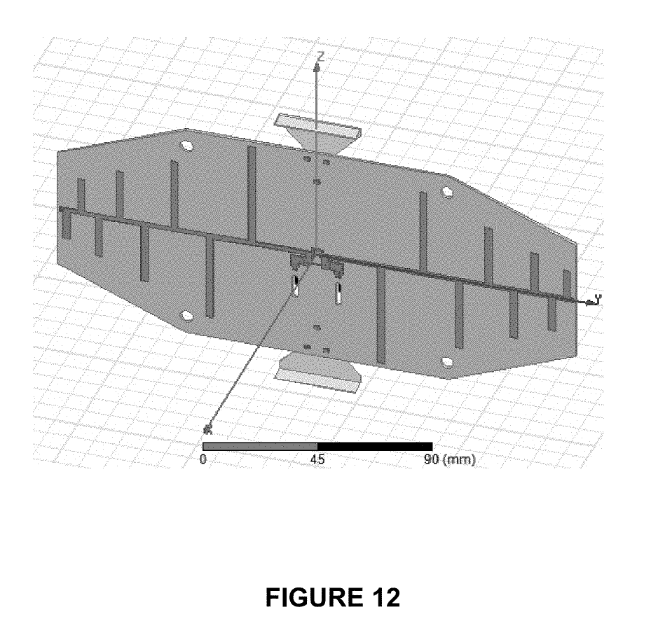

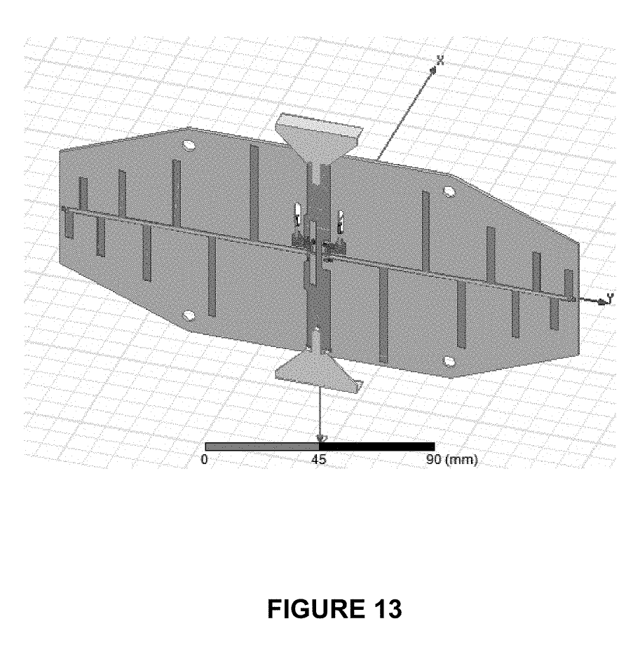

FIG. 11 is a 3D image of a single PCB broad band diversity antenna system that comprises a system of LPAs and a dipole antenna according to the invention; FIG. 12 is a front side view of the single PCB broad band diversity antenna system that comprises a system of LPAs and a dipole antenna according to the invention; and FIG. 13 is a back side view of the single PCB broad band diversity antenna system that comprises a system of LPAs and a dipole antenna according to the invention.

### Circuit

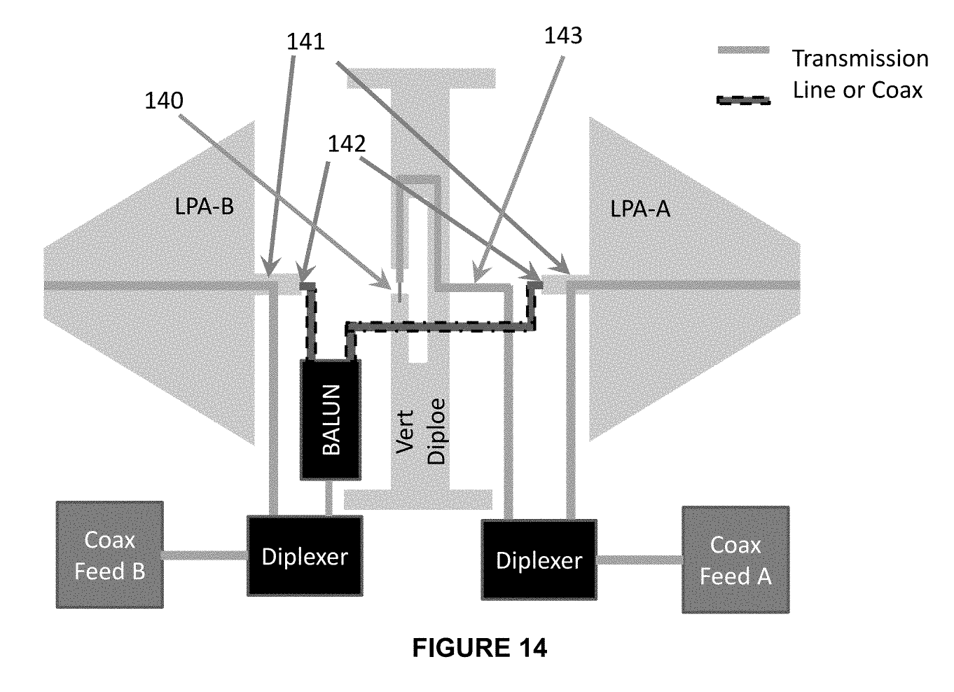

FIG. 14 is a schematic representation of a broad band diversity antenna system that comprises a system of log periodic antennas (LPA) and a dipole antenna. In FIG. 14, a low band feed point 140 connects the low band vertical feed line 143 from a diplexer to the vertical dipole; a balun, via a diplexer, connects the low band differential horizontal feeds to the low band horizontal antenna elements. The high band feeds 141 connect the RF device, via a diplexer and balun, to respective LPAs A and B. In the embodiment shown in FIG. 14, the LPAs and dipole are not coplanar.

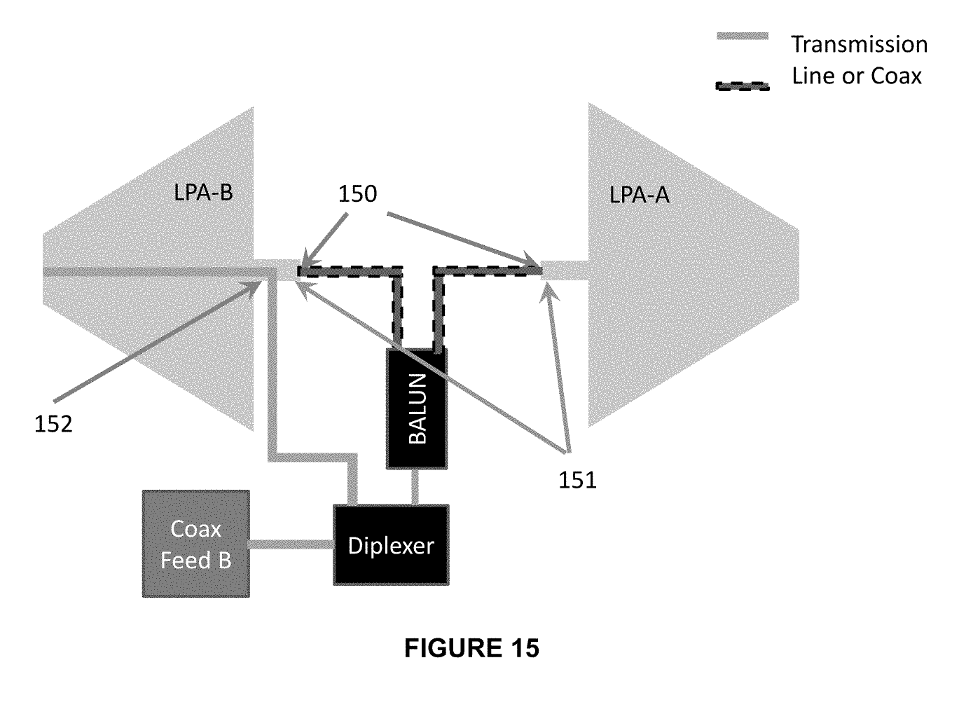

FIG. 15 is a schematic representation of a broad band diversity antenna system that comprises a system of LPAs and a dipole antenna according to the invention. The high band LPA is fed via an LPA high band feed 152. For the low band horizontal dipole, both the LPAs are fed at the common mode point 150, as shown. As such, currents flowing to and from this point are equally divided both up and down. Hence, at the low band the LPA front and back metal planes are shorted together 151 and there is no vertically radiating component, only a horizontal component. This arrangement can also be used for LPA tuning. By using both the LPAs, horizontal, polarized, balanced low band radiation results.

While an LPA is used in this example, in other embodiment of the invention other antennas, such as conical, Yagii, dipole, and many other balanced and unbalanced antenna systems can be used. Further, while a balun has been used in this embodiment other combiners, such as delta sigma or discrete circuits can be used to achieve a similar result.

A further improvement allows for combinations of these antennas, such as an LPA with a Yagii, and so on. Such combinations can be provided for various beam pattern and bandwidth requirements.

In this embodiment, the LPA provides substantially omnidirectional horizontal coverage, using one or the other of the LPAs. A further improvement uses higher gain high band antennas. By way of example, the horizontal polarized low band antenna can be duplicated with two more LPAs or similar antennas by duplicating the system and rotating the second system by 90 degrees. This provides for four high band, high gain orthogonal antennas and two low band, horizontal orthogonal dipole antennas. This process can continue as desired. While this embodiment is described in the azimuthal plane, one skilled in the art will appreciate that the system described can operate in any chosen plane.

Using the vertical dipole as described limits the horizontal vertical coverage to omnidirectional and it therefore remains a single antenna. Further improvement can be achieved with a system of directed antennas in its place, thus permitting for additional independent beams. Such the antenna system is necessarily larger in size. This allows the possibility of further system extensions that are not limited to the LPA and dipole described above.

### LPA Construction

LPAs are typically self supporting structures with only an air dielectric between the top and bottom antenna structures, as shown in the first example. However, embodiment of the invention requires more structural support.

One embodiment supports the two metal structures with a thin PCB material on the outer side for each. This allows the metal structure to be printed on the inner side of the PCBs and, accordingly, the antenna impedance remains unaltered, particularly in the overlapping region. This also allows the efficiency to remain high because there is only air and not a lossy dielectric between the metal layers.

A presently preferred embodiment of the invention prints the two metal layers on a single PCB. This makes the antenna assembly much less expensive to build and assemble. However, there are two issues in this case, i.e. the dielectric material increases the loss in the feed system, and the higher dielectric constant slows down the travelling wave in the feed system. This becomes more of an issue as the LPA bandwidth increases.

A solution to this problem is to offset the feed system by shifting the facing side up and the back side down. As the offset increases the impedance is increased and the group delay is decreased, approaching the effective relative dielectric of 1.0. Accordingly, the performance of the antenna system approaches the air-loaded dielectric, thus improving the efficiency and bandwidth capability. This also allows a much thinner, single-layer PCB material to be used. The thinner PCB material allows the electric field to be dominated by the air dielectric, not by the PCB material, and yet maintain the overall strength and robustness of the antenna system. In some cases, small adjustment to the element lengths may be required. Some tapering of the feed system might also help with the taper corresponding somewhat with the taper of the element lengths.

### Specification

The following are typical specifications of a preferred embodiment of the invention:

### LTE Bands:

Low band 700 MHz to 960 MHz
High band 1.4 GHz to 2.7 Ghz

### Directivity:

Two times low band omnidirectional 1 dBi nominal as for a dipole, where one dipole is vertical and the other dipole is horizontal
Two times high band unidirectional 5 dBi nominal as for an LPA, where both high band antennas are oppositely directed

### Match:

### Return Loss>10 dB

### Efficiency:

50% to 90%

### Polarization:

Vertical all bands
Horizontal for the second low band antenna

Accordingly, return loss is typically better than 10 dB all bands, isolation is better than 20 dB all bands, low band gain omnidirectional is 1 dBi to 2 dBi, high band forward gain is 6.5 dBi to 7.5 dBi, and the high band front-to-back ratio is 15 dB to 20 dB. The low and high band may be combined with a suitable diplexer for each antenna system.

### Other Embodiments

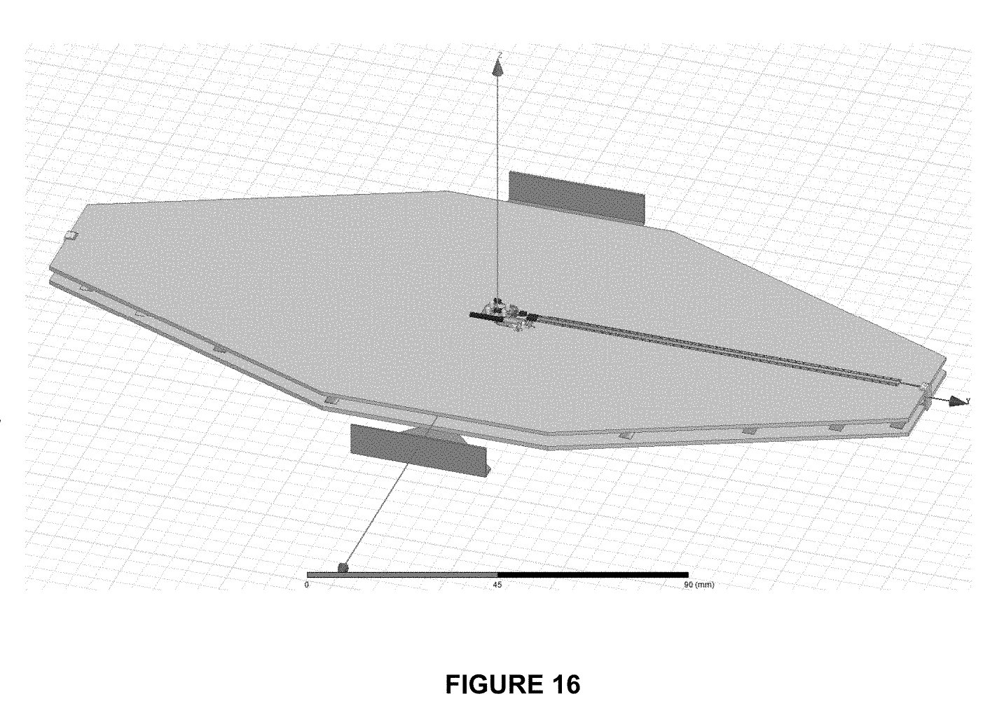

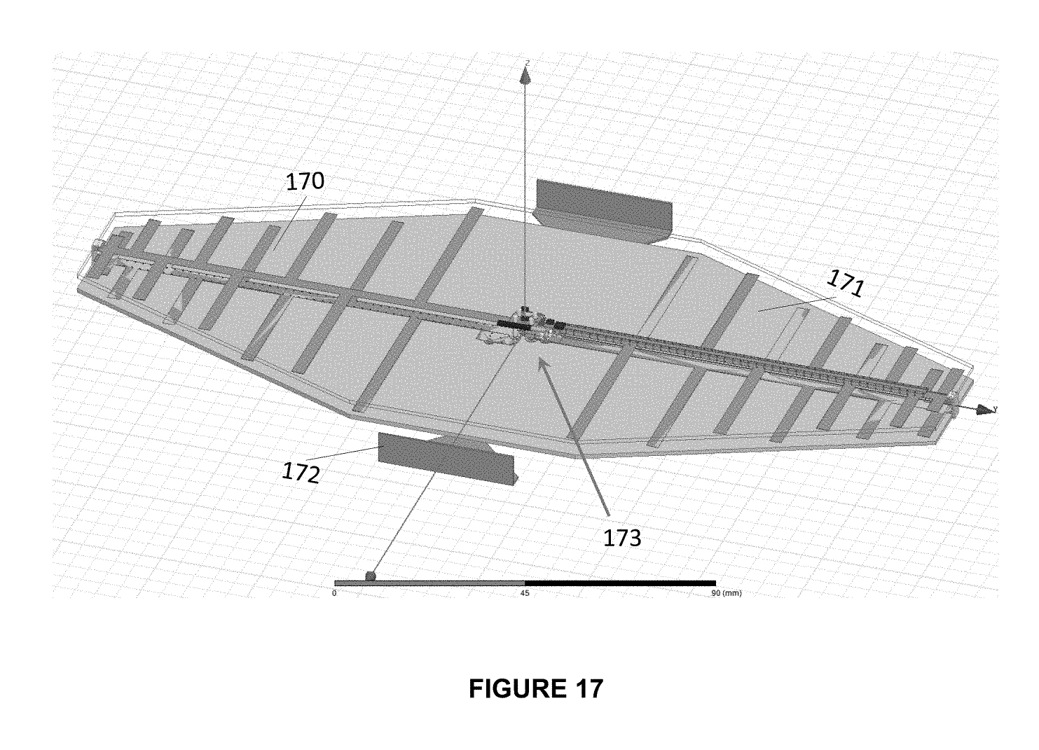

FIG. 16 is a 3D representation of a broad band diversity antenna system that comprises a system of LPAs and a dipole antenna according to the invention; and FIG. 17 is a further 3D representation of a broad band diversity antenna system that comprises a system of LPAs and a dipole antenna according to the invention. FIG. 16 shows a two PCB antenna system. In FIG. 17, the antenna system is depicted as though the PCB is transparent. LPA A 171 and LPA B 170, which also comprise the low band horizontal dipole, are shown, as well as the low band vertical dipole 172, and a low band horizontal dipole matching circuit 173.

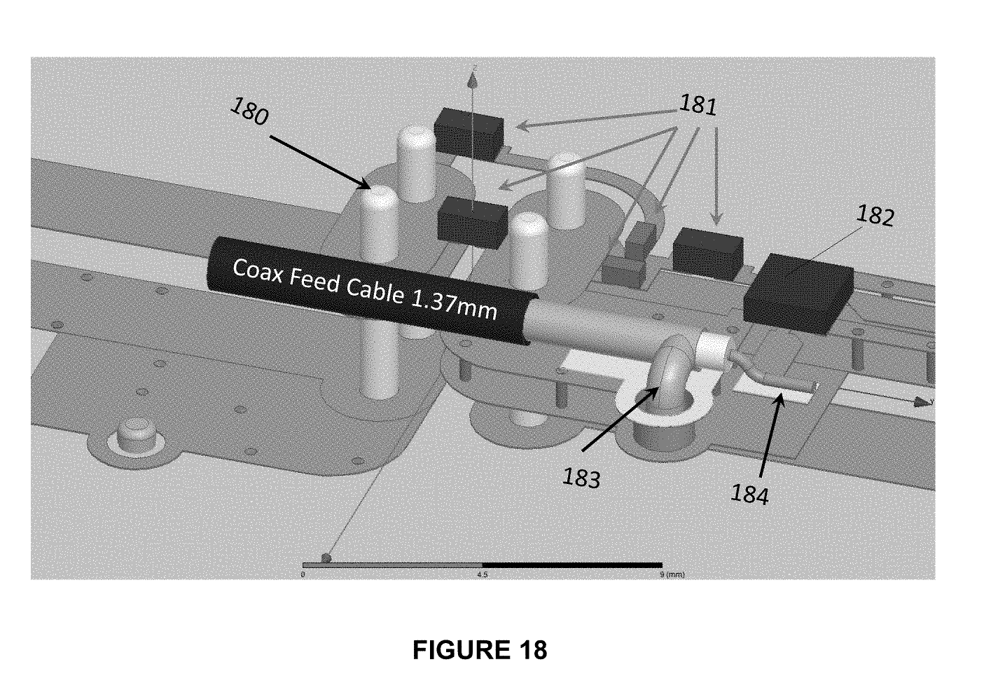

FIG. 18 is a close up schematic representation of a low band match element in a broad band diversity antenna system that comprises a system of LNAs and a dipole antenna according to the invention. The system comprises various match components 181 and a diplexer 182. The coax feed cable in this embodiment is a 1.37 mmm cable having a coax shield termination 13 and coax conductor termination 184 as shown. Terminal pins 180 electrically connect the front PCB with the back PCB. This is required for the LPA.

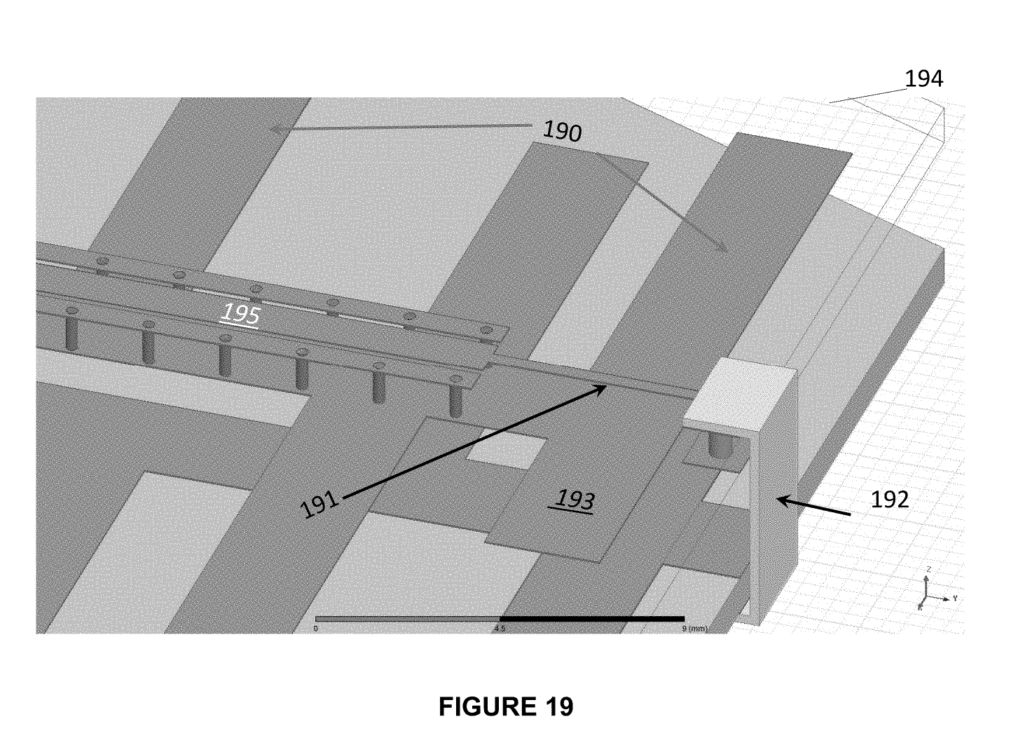

FIG. 19 is a close up schematic representation of an LPA feed element in a broad band diversity antenna system that comprises a system of LPAs and a dipole antenna according to the invention. In FIG. 19, a PCB 194 supports the antenna elements 190. The structure also includes a feed click 192, cap stub 193, series inductor 191 and grounded coplanar waveguide 195.

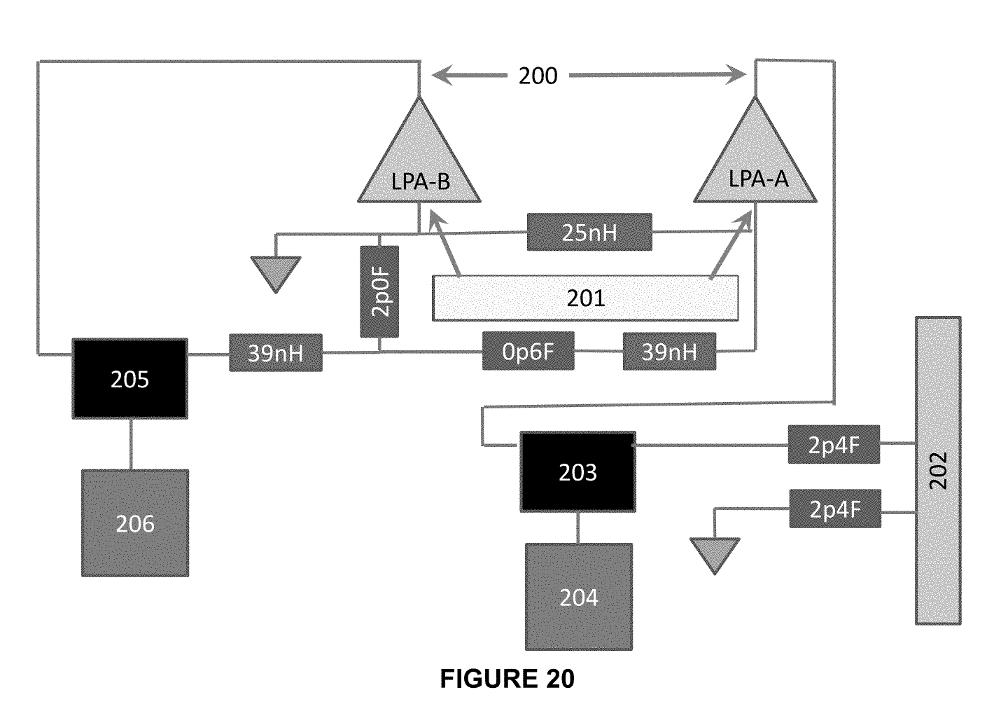

FIG. 20 is a schematic diagram showing a discrete matching circuit for a broad band diversity antenna system that comprises a system of LPAs and a dipole antenna according to the invention. In FIG. 20, coax feed A 204 connect an RF device through a diplexer 203 to a top loaded vertical dipole antenna 202 and to LPA A. Coax feed B 206 connects an RF device through a diplexer 205 to LPA b and LPA A via a low band differential feed 201. Each of the diplexers 203, 205 also connect to respective LPAs A and B via a high band feed 200.

### System Including Control PCB

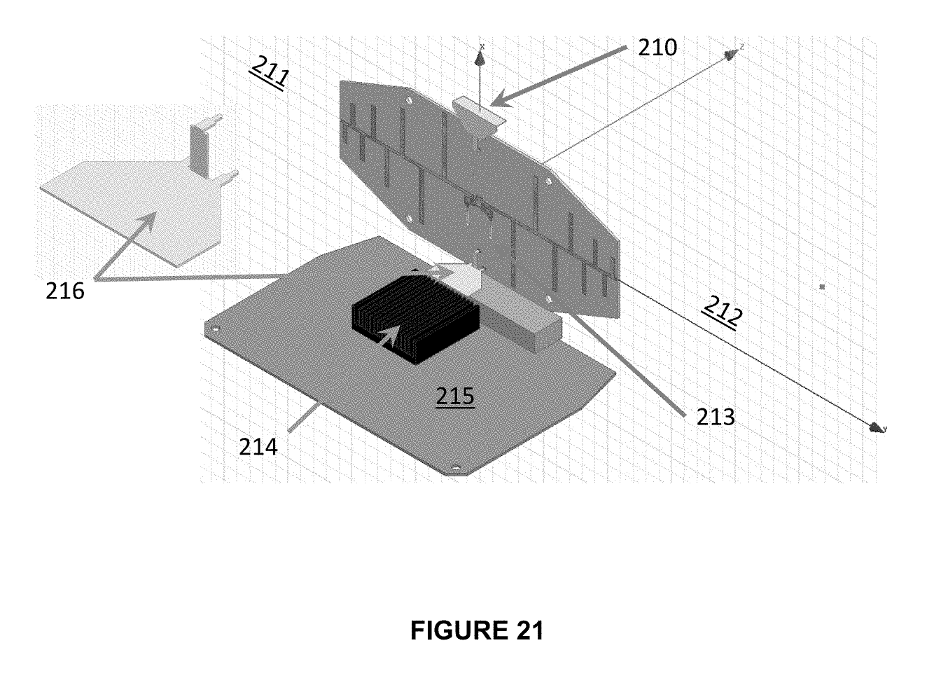

FIGS. 21-23 show how the antenna system is adjusted to compensate for loading effects in the presence of a substantial control PCB and heat sink. The only antenna impacted in such case is the low band vertical dipole. The correction requires adjustment to the bottom paddle of the dipole to compensate for capacitive loading of the lower end by the control PCB.

FIG. 21 is a front side view of an antenna and a main board for a broad band diversity antenna system that comprises a system of LPAs and a dipole antenna according to the invention. In FIG. 21, the main board 215 includes a heat sink 214. The antenna system comprises a primary side 211 and a secondary side 212. The low band antenna includes a primary paddle top 210 and a modified paddle bottom 216. The cable slots 213 are below a center line.

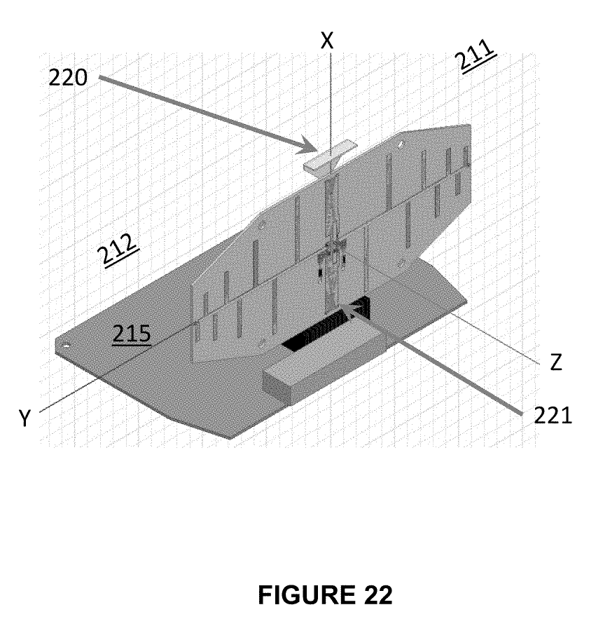

FIG. 22 is a back side view of an antenna and a main board for a broad band diversity antenna system that comprises a system of LPAs and a dipole antenna according to the invention. In FIG. 22, the low band primary antenna paddle 220 is shown relative to the component and printed low band antenna side 221 of the antenna assembly.

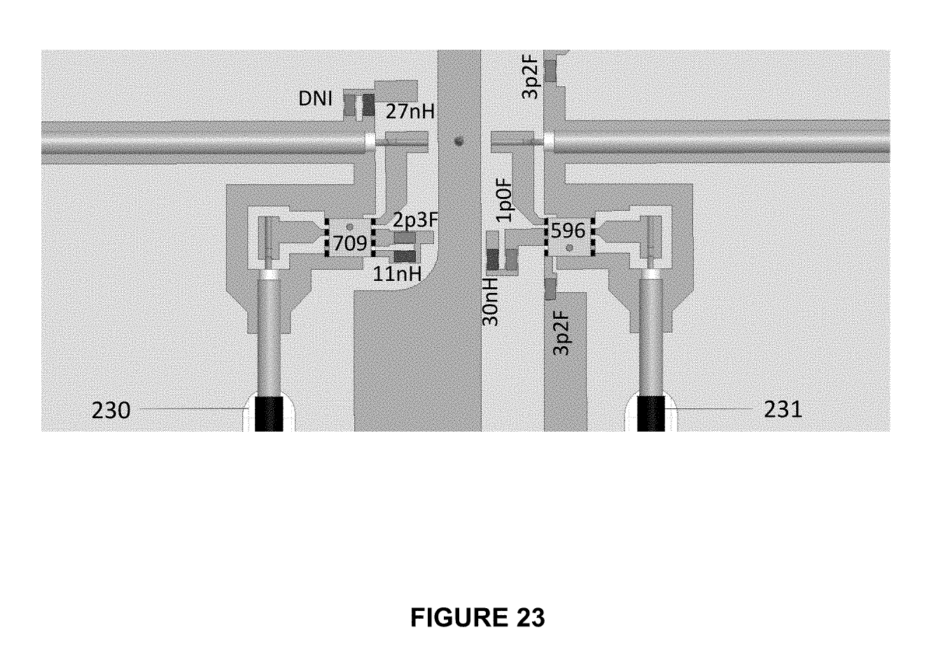

FIG. 23 is a back side view showing component values a main board for a broad band diversity antenna system that comprises a system of LPAs and a dipole antenna according to the invention. In FIG. 213, the primary feed 231 and secondary feed 230 are shown connected to the circuit similar to that of FIG. 20. The values shown are for the embodiment depicted. Those skilled in the art will appreciate that other values are used in other configurations. FIG. 23 is a PCB layout for a specific embodiment of the invention. If there is no diplexer 709 available then this component may be approximated by the diplexer 596 by flipping the diplexer 596 horizontally around its vertical axis.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A broad band diversity antenna system, comprising:
at least two log periodic antennas (LPA) operable in a first band;
a feed to a back end of each of said two LPAs to configure said two LPAs as a balanced dipole operable in a second band in any of a horizontal and a vertical polarization.

2. The antenna system of claim 1, said feed further comprising:
a balun.

3. The antenna system of claim 2, wherein said balun is constructed from any of coax cable and a transmission line.

4. The antenna system of claim 1, further comprising:
a dual band antenna comprising a low band 700 MHz to 960 MHz top loaded dipole and a high band 1.4 GHz to 2.7 GHz broad band LPA.

5. The antenna system of claim 1, wherein said at least two LPAs are fixed.

6. The antenna system of claim 1, said at least two LPAs further comprising:
two oppositely pointing LPAs for a high band, each LPA having a cardioid pattern in both vertical and horizontal directions, where polarization is vertical in an azimuth plane.

7. The antenna system of claim 1, wherein said at least two LPAs are placed back to back to ensure isolation between the antennas in said antenna system.

8. The antenna system of claim 1, said dipole antenna further comprising:
a low band, single top loaded vertical dipole configured for operation in a differential mode between proximal ends of said at least two LPAs.

9. The antenna system of claim 1, said at least two LPAs further comprising:
interleaved elements that are printed on two opposing PCBs having copper on facing surfaces.

10. The antenna system of claim 9, said balanced dipole further comprising:
a top loaded, low band, vertical dipole coupled by a delta match.

11. The antenna system of claim 10, said delta match comprising:
a series capacitor, wherein said capacitor is split on either side of a differential feed.

12. The antenna system of claim 9, wherein said at least two LPA antennas are isolated;
said balanced dipole further comprising a low band horizontal dipole formed by driving a common mode of said at least two LPA antennas in a differential fashion.

13. The antenna system of claim 1, said at least two LPAs further comprising:
interleaved elements that are printed on a single PCB.

14. The antenna system of claim 1, further comprising:
a low band feed point connected to a low band vertical feed line via a diplexer to vertical dipole elements within said at least two LPAs;
a first balun connected to low band differential horizontal feeds via a diplexer to horizontal dipole elements within said at least two LPAs; and
a second balun connected to high band feeds via a diplexer to respective LPAs of said at least two LPAs.

15. The antenna system of claim 1, further comprising:
four high band, high gain orthogonal antennas and two low band, horizontal orthogonal dipole antennas comprising at least two additional LPAs comprising duplicates of said at least two LPAs that are rotated by 90 degrees relative to said at least two LPAs.

16. The antenna system of claim 1, said at least two LPAs further comprising:
two metal layers printed on a single PCB; and
an offset feed system created by shifting an LPA formed on a facing side of said PCB up and an LPA formed on a back side of said PCB down;
wherein impedance is increased and group delay is decreased as said offset increases.

17. The antenna system of claim 1, said at least two LPAs further comprising:
a feed for a vertical dipole; and
a feed for a horizontal dipole.

18. The antenna system of claim 1, further comprising:
a low band vertical dipole element of said antenna system comprising a primary paddle top and a paddle bottom that is adjustable to compensate for capacitive loading effects on said low band vertical dipole element of said antenna system in the presence of a control PCB and/or heat sink.
